(19) United States
(12) Patent Application Publication
(10) Pub. No.: US 2011/0248020 A1
(43) Pub. Date: Oct. 13, 2011

(54) ELECTROMAGNETIC OVEN FOR BARBECUE

(76) Inventor: Canrong Yuan, Guangdong (CN)

(21) Appl. No.: 13/140,918

(22) PCT Filed: Feb. 28, 2009
(86) PCT No.: PCT/CN09/70592

§ 371 Date: Jun. 20, 2011

(51) Int. Cl. H05B 6/02

(52) U.S. Cl. 219/618

(57) ABSTRACT

A kitchen utensil, especially an oven for barbecue. The oven for barbecue is composed of a base, an electromagnetic coil, a vitrolite, and a heating unit. The heating unit is provided in the receiving portion of the base, and is heated by the electromagnetic induction of the electromagnetic coil. Several supporting feet are provided in the receiving portion of the base for supporting the heating unit, wherein at least one supporting foot is a good conductor for heat. A temperature sensor is provided in at least one heat-conductive supporting foot for measuring the temperature of the heating unit. The temperature sensor is electrically connected to the control system in the base.

### TECHNICAL FIELD

The utility model relates to a cooking utensil, particularly to a barbecue oven.

### BACKGROUND

The existing barbecue oven is divided into resistive barbecue oven and electromagnetic barbecue oven according to the heating mode, and the resistive barbecue oven has the disadvantages of slow temperature rise and low safety while in use; however, the electromagnetic barbecue oven just solves the above problems and has the advantages of fast temperature rise and safe use. Thus the electromagnetic barbecue oven is very popular. However, as the electromagnetic barbecue oven heats up fast, if its temperature cannot be controlled properly, the overheating that easily occurs may cause food burn. Thus, it is necessary to implement a good temperature control device to control the heating temperature of a barbecue oven in an accurate and timely fashion.

### SUMMARY

The purpose of the utility model is to provide a safe electromagnetic barbecue oven with the heating temperature of the barbecue oven controlled in an accurate and timely fashion.

The other purpose of the utility model is to provide an electromagnetic barbecue oven with simple structure, which is easy to manufacture.

In order to achieve the above purposes, the utility model adopts the following technical schemes.

The electromagnetic barbecue oven mainly comprises a base, electromagnetic coil(s), a ceramic panel and a heating element, wherein the heating element is contained in the containing part of the base and produces heat through the electromagnetic induction of the electromagnetic coil(s);

several support legs are arranged in the containing part of the base to support the heating element, and at least one support leg is a good heat conductor; at least one heat conducting support leg is provided a temperature detection sensor to detect the temperature of the heating element, and the temperature detection sensor is electrically connected with the control system in the base.

In the above scheme, several support legs are fixed outside the ceramic panel.

The heat conducting support leg is a metal body fixed on the base, in a form such as a spring leaf.

A temperature resistance bracket is arranged on the base; the ceramic panel is inserted in the inner middle part of the bracket, and several support legs are fixed on the bracket peripheral to the ceramic panel.

The barbecue oven provided by the utility model produces heat by electromagnetic induction and has the advantages of fast temperature rise, high efficiency and superior safety. Meanwhile, temperature is measured by utilizing the support leg that supports the heating element as temperature sampling points, and the temperature measurement is both steady and accurate. Therefore, the heating temperature of the barbecue oven is controlled accurately and timely, and the utility model has the advantage of good practicality.

### BRIEF DESCRIPTION OF FIGURES

FIG. 1 is a schematic diagram of the utility model;

FIG. 2 is a schematic diagram of the zoomed in view of the structural features of A in FIG. 1;

FIG. 3 is a view of the three dimensional structure of the utility model;

FIG. 4 is a schematic diagram of the distribution of the support legs in an embodiment of the utility model.

### DESCRIPTION OF FIGURE NUMBERS

10 Base; 20 Electromagnetic Coil; 30 Heating Element; 40 Support Leg; 50 Temperature Detection Sensor; 11 Bracket; 51 Pressing Piece.

### DETAILED DESCRIPTION

The utility model will further be described in detail in accordance with the figures.

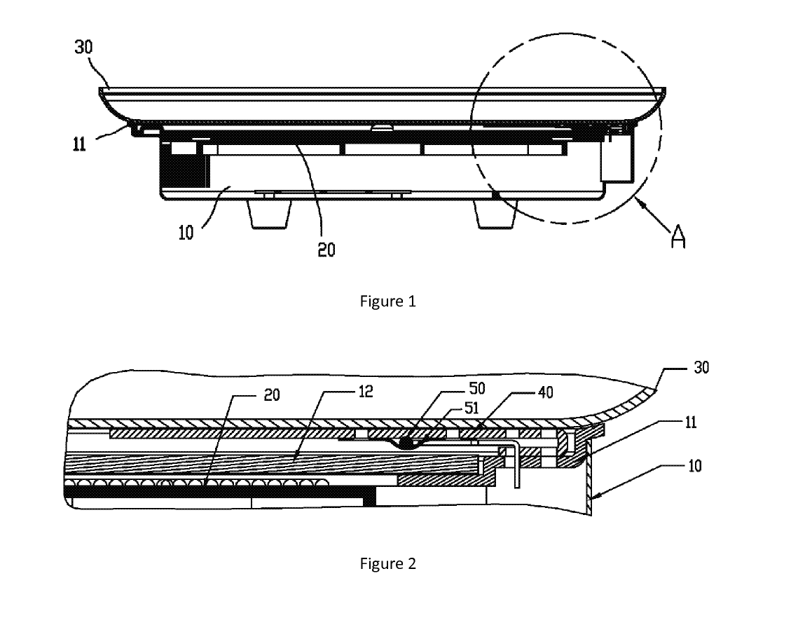

As shown in FIG. 1 to FIG. 3, the electromagnetic barbecue oven described in the utility model mainly comprises a base 10, electromagnetic coil(s) 20 and a heating element 30.

The heating element 30 is contained in the containing part of the base and produces heat through the electromagnetic induction of the electromagnetic coil(s); several support legs are arranged in the containing part of the base to support the heating element; at least one support leg is a good heat conductor; at least one heat conducting support leg is provided a temperature detection sensor 50 to detect the temperature of the heating element, and the temperature detection sensor is electrically connected with the control system in the base; and the control system is a system frequently used on the electromagnetic electrical apparatus, such as a control system for induction cooker. Thus, the function mechanism of the control system is not described in detail here.

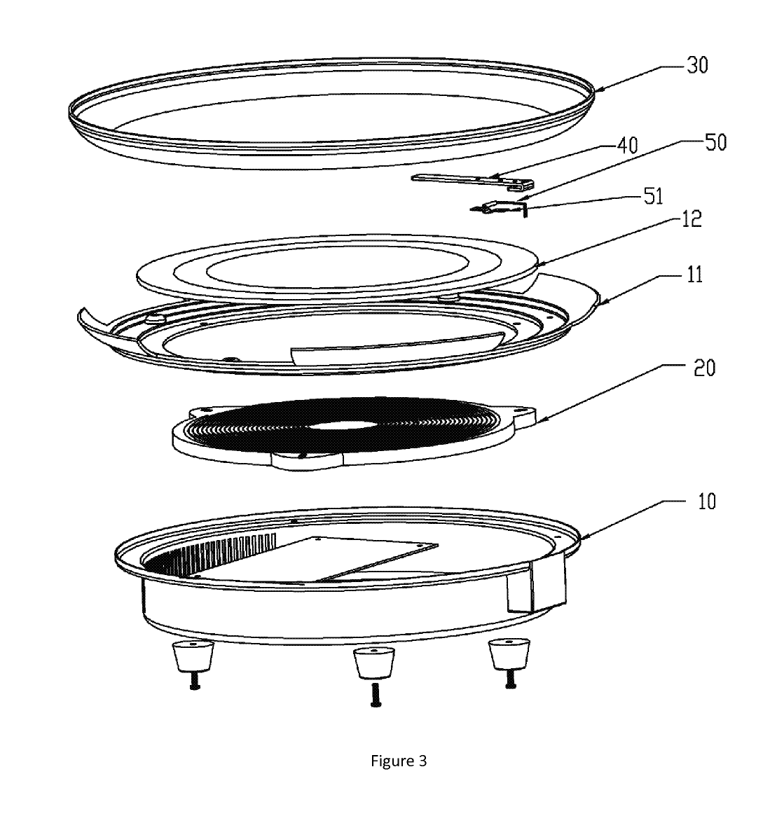

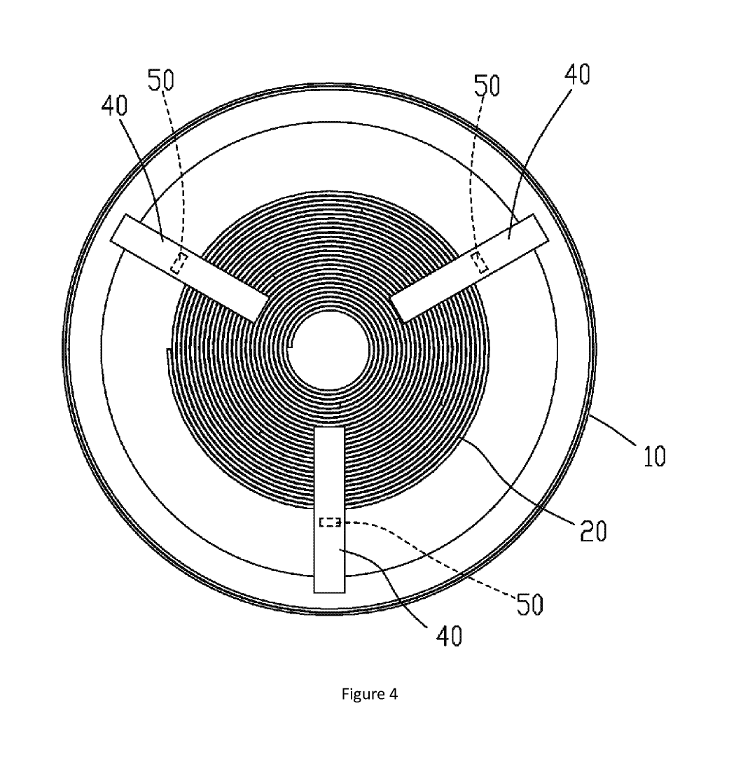

The heat conducting support leg 40 is a metal body fixed on the base, in a form such as a spring leaf, and can be fixed on the base 10 by riveting, welding, screwing and other ways and the temperature detection sensor 50 is connected with the support leg and can be fixed by encapsulating or riveting. In one embodiment, the temperature detection sensor 50 is pressed by a pressing piece 51, and the heat conducting support leg 40 is a spring leaf; the pressing piece 51 is fixed on the spring leaf by riveting; the temperature detection sensor 50 is directly fixed on the spring leaf to enable the temperature detection sensor 50 and the spring leaf to form a heat conducting system, and the temperature of the heating element 30 is detected by attaching the spring leaf to the bottom of the heating element 30, as shown in FIG. 2 and FIG. 3. Of course, the heat conducting support leg 40 not only can be made of spring leaves, but also can be made of other heat conducting materials.

In one embodiment, a bracket 11 is arranged on the base, and the bracket 11 is an annular body of which the inner middle part is in a concave arc shape to form the containing part for containing the heating element 30. The bracket 11 is a temperature resistance element. The heating element 30 is a baking tray. The ceramic panel 12 is arranged above the electromagnetic coil(s) 20, and the support legs 40 are respectively arranged around the ceramic panel 12 and are arranged higher than the upper surface of the ceramic panel 12 to support the heating element 30. The ceramic panel 12 is in a sheet shape, is inserted in the inner middle part of the bracket 11, and is sealed to be watertight. The support legs 40 are fixed on the bracket 11 in the mode of riveting, welding, screwing, and the like, or alterntively the support legs 40 and the bracket 11 are made as a single piece. FIG. 4 shows the schematic diagram of threes support legs 40 uniformly distributed, and the three support legs 40 are made of spring leaves and are good heat conductors. Each of the three support legs 40 is provided with a temperature detection sensor 50 to detect the heating temperature of the heating element 30 at multiple points. The support legs 40 are installed on the bracket without any need to impair the structure of the ceramic panel 12, which not only overcomes the conventional defect associated with drilled holes in a panel, but also preserves the integrity of the ceramic panel 12, and simplifies the manufacturing of the ceramic panel 12.

In the utility model, non-heat conducting support legs can be made together with the base 10 in the mode of injection molding, and not excluded here is the possibility of the mode of assembly.

Each support leg 40 of the utility model can also be installed as follows: the support leg 40 is provided with a U-shaped clamping part; the edge of the ceramic panel 12 is sheathed and clamped by the U-shaped clamping part; and the support leg 40 is fixed and installed together with the ceramic panel 12 to fix the support leg 40 and the ceramic panel 12 together. This also ensures that the structure of the ceramic panel 12 is not damaged.

In one embodiment of the utility model, the heating element 30 is contained in the containing part of the base and is in tight contact with the support legs 40, wherein the heat conducting support leg 40 and the temperature detection sensor 50 make up the heat conducting system, so that the sampling and detection of the temperature detection sensor 50 can be guaranteed; during the actual manufacture, the temperature detection can be realized as the sensor 50 detects temperature by directly contacting the bottom of the heating element 30 after the temperature detection sensor 50 is installed on the support leg 40; the heating element 30 produces heat by the electromagnetic induction of the electromagnetic coil 20 to achieve the purpose of baking and has the advantages of fast temperature rise, high efficiency and high safety. Temperature is measured by utilizing the support leg that supports the heating element as temperature sampling points, and the temperature measurement is both steady and accurate. Therefore, the heating temperature of the barbecue oven is controlled accurately and timely, and the barbecue oven has the advantage of good practicality.

The above embodiments are only preferable embodiments of the utility model and are not used to restrict the range of the utility model. The structure design of the utility model can be applied to other electromagnetic heating devices including induction cooker, electromagnetic pressure cooker, and the like, so as to detect temperature accurately and timely and ensure the operating stability of the heating device. Thus, any equivalent change or modification made in accordance with the principle of the utility model shall be covered in the protection range of the utility model.

I claim:

1. An electromagnetic barbecue oven is characterized in that the barbecue oven is provided with a base, electromagnetic coil(s), a ceramic panel and a heating element, wherein the heating element is contained in a containing part of the base and produces heat through the electromagnetic induction of the electromagnetic coil(s); several support legs are arranged in the containing part of the base to support the heating element, with at least one support leg being a good heat conductor; at least one heat conducting support leg is provided a temperature detection sensor to detect the temperature of the heating element, and the temperature detection sensor is electrically connected with the control system in the base.

2. An electromagnetic barbecue oven according to claim 1 is characterized in that several support legs are fixed outside the ceramic panel.

3. An electromagnetic barbecue oven according to claim 1 or claim 2 is characterized in that the heat conducting support leg is a metal body fixed on the base.

4. An electromagnetic barbecue oven according to claim 3 is characterized in that the metal body is a spring leaf.

5. An electromagnetic barbecue oven according to claim 1 is characterized in that a temperature resistance bracket is arranged on the base, wherein the ceramic panel is inserted in the inner middle part of the bracket, and several support legs are fixed on the bracket peripheral to the ceramic panel.
